(19) United States
(12) Patent Application Publication
(10) Pub. No.: US 2025/0044731 A1
(43) Pub. Date: Feb. 6, 2025

(54) IMAGE FORMING APPARATUS

(71) Applicant: FUJIFILM Business Innovation Corp., Tokyo (JP)

(72) Inventors: Shinya HASEGAWA, Kanagawa (JP); Ryosuke Nara, Kanagawa (JP)

(73) Assignee: FUJIFILM Business Innovation Corp., Tokyo (JP)

(21) Appl. No.: 18/435,570

(22) Filed: Feb. 7, 2024

(30) Foreign Application Priority Data
Aug. 1, 2023 (JP) 2023-125436

(51) Int. Cl. G03G 15/00; B65H 3/44

(52) U.S. Cl. CPC G03G 15/6511; B65H 3/44; G03G 15/6514; G03G 15/6529; G03G 15/6588; B65H 2404/14; B65H 2513/50; B65H 2701/1131; G03G 2215/00599

(57) ABSTRACT

An image forming apparatus includes a housing that has left and right side surfaces; a manual feed tray that protrudes from one side surface of the left and right side surfaces; a manual feeding device that feeds a sheet from the manual feed tray; a first sheet tray that is arranged inside the housing, and faces the manual feed tray such that at least a part of the first sheet tray overlaps one end portion of the manual feed tray in a gravity direction; a first feeding device that feeds a sheet from the first sheet tray; and a common conveyance roll pair that is arranged inside the housing, and first receives and conveys both the sheet fed from the first feeding device and the sheet fed from the manual feeding device.

### CROSS-REFERENCE TO RELATED APPLICATIONS

This application is based on and claims priority under 35 USC 119 from Japanese Patent Application No. 2023-125436 filed Aug. 1, 2023.

### BACKGROUND

### (i) Technical Field

The present invention relates to an image forming apparatus.

### (ii) Related Art

JP4555253B (claims 1 and 3, and FIG. 1) has disclosed an image forming apparatus including a sheet conveyance apparatus that includes a first conveyance unit that pinches and feeds a sheet; a first guide member that is provided on an upstream side of the first conveyance unit and guides to the first conveyance unit; a second guide member that is provided on an upstream side of the first guide member and protrudes into a conveyance path from a guide surface of the first guide member; and a third guide member that is provided on a downstream side of the first conveyance unit and guides a conveyance direction of the sheet in a direction different from a guide direction of the first guide member.

In addition, JP4555253B (claims 1 and 3, and FIG. 1) has disclosed that, in the sheet conveyance apparatus, a second conveyance unit is provided which pinches a leading edge of the conveyed sheet and conveys the sheet using a conveyance belt and a roller by providing the conveyance belt on a downstream side of the third guide member and on an outer peripheral side of a conveyance surface and providing the roller at a position facing the conveyance belt, a vibration isolating member that reduces a contact sound of a trailing edge of the sheet coming into contact with the first guide member in a width direction is included in the first guide member, and the vibration isolating member is arranged only on both sides of the sheet in the width direction.

JP2010-89910A (claim 1 and FIG. 1) has disclosed a printing apparatus that includes a paper feeding mechanism that forms an image using an image forming unit on a printing sheet conveyed on a conveyance route.

In addition, JP2010-89910A (claim 1 and FIG. 1) has disclosed that the paper feeding mechanism includes three or more paper feeding paths, and a guide member that regulates the conveyance of the sheet in each paper feeding path so that joining points of the paper feeding paths do not coincide with each other, and each paper feeding path has a widened portion, which loosens the printing sheet related to the paper feeding, on an upstream side of the guide member.

### SUMMARY

Aspects of non-limiting embodiments of the present disclosure relate to an image forming apparatus that narrow a left and right width of a housing in an image forming apparatus that includes a manual feed tray that protrudes from one side surface of left and right side surfaces of the housing; a manual feeding device that feeds a sheet from the manual feed tray; a first sheet tray that is arranged inside the housing, and faces the manual feed tray such that at least a part of the first sheet tray overlaps one end portion of the manual feed tray in a gravity direction; a first feeding device that feeds a sheet from the first sheet tray.

Specifically, the object of the exemplary embodiment of the invention is to narrow the left and right width of the housing in the image forming apparatus, as compared with a case where an internal conveyance roll pair that first receives and conveys the sheet fed from the first feeding device, and a manual conveyance roll pair that first receives and conveys the sheet fed from the manual feeding device are individually provided.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including:
a housing that has left and right side surfaces;
a manual feed tray that protrudes from one side surface of the left and right side surfaces;
a manual feeding device that feeds a sheet from the manual feed tray;
a first sheet tray that is arranged inside the housing, and faces the manual feed tray such that at least a part of the first sheet tray overlaps one end portion of the manual feed tray in a gravity direction;
a first feeding device that feeds a sheet from the first sheet tray; and
a common conveyance roll pair that is arranged inside the housing, and first receives and conveys both the sheet fed from the first feeding device and the sheet fed from the manual feeding device.

### BRIEF DESCRIPTION OF THE DRAWINGS

Exemplary embodiment(s) of the present invention will be described in detail based on the following figures, wherein:

FIG. 1 is a schematic diagram of an image forming apparatus according to a first exemplary embodiment of the present invention;

FIG. 2 is a schematic diagram of an image forming unit in the image forming apparatus of FIG. 1;

FIG. 3 is a schematic diagram illustrating a manual feed tray, a first sheet tray, a conveyance path of the sheet, and the like in the image forming apparatus of FIG. 1;

FIG. 4 is a schematic diagram illustrating an arrangement state of a manual feeding device, a first feeding device, a common conveyance roll pair, and the like in FIG. 3;

FIG. 5 is a schematic diagram illustrating a portion including a manual feed tray, a first sheet tray, a second sheet tray, conveyance paths of sheets, and the like when an external paper feeding device is connected to the image forming apparatus in FIG. 1;

FIG. 6 is a schematic diagram illustrating an arrangement state of a manual feeding device, a first feeding device, a common conveyance roll pair, a second feeding device, a first relay conveyance roll pair, and the like in FIG. 5;

FIG. 7 is a schematic diagram illustrating a part of conveyance paths of sheets in FIG. 6; and

FIG. 8 is a schematic diagram illustrating an image forming apparatus as a comparison target.

### DETAILED DESCRIPTION

Hereinafter, exemplary embodiments of the present invention will be described.

### First Exemplary Embodiment

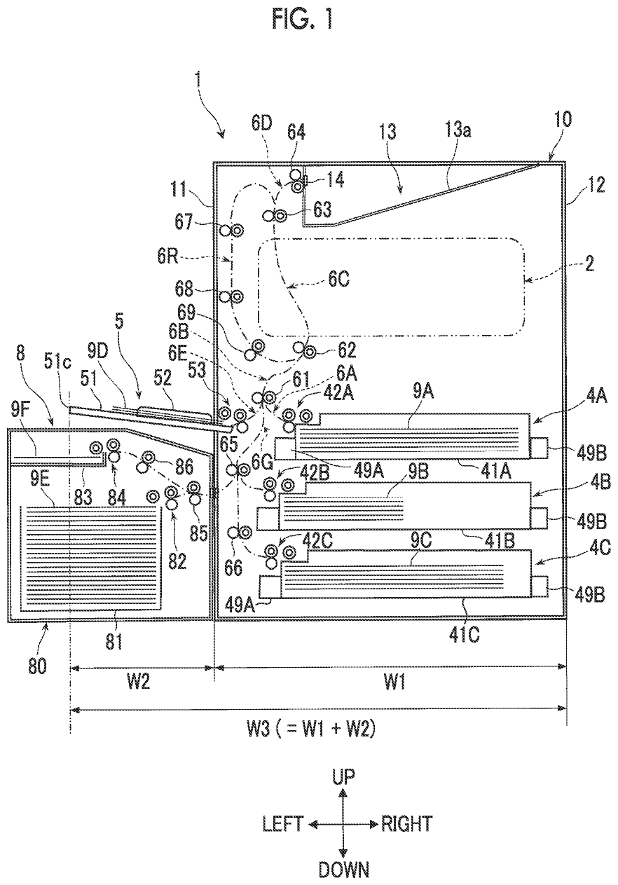

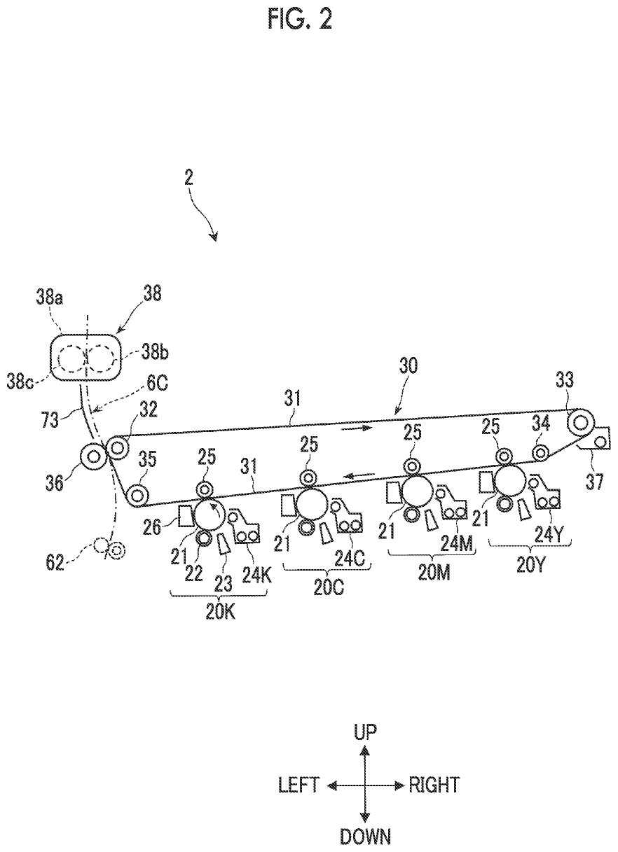

FIG. 1 is a schematic diagram of an image forming apparatus 1 according to a first exemplary embodiment of the present invention. FIG. 2 is a schematic diagram of an image forming unit in the image forming apparatus 1.

In this specification and the drawings, substantially identical components are denoted by the identical reference numerals, and redundant description of the identical components will be omitted in this specification.

### Overview of Image Forming Apparatus

The image forming apparatus 1 is an apparatus that forms a desired image on a sheet.

The image forming apparatus 1 according to the first exemplary embodiment is configured as an apparatus that can form an image corresponding to image information that is input from an external device by being connected to the external device such as a personal computer, an information terminal, and an image reading device, for example. The image information is, for example, information regarding images such as text, graphics, photographs, and patterns.

As illustrated in FIG. 1, the image forming apparatus 1 includes a housing 10, an image forming unit 2, a sheet tray 4, a manual feed tray 5, and an image processing unit, a drive device, a power supply device, a control device, and the like that are not illustrated. The dash-dot chain lines in FIG. 1 indicate various conveyance paths 6 when a sheet 9 is conveyed inside the housing 10 or the like.

The housing 10 is a box-shaped structure manufactured to have a desired external shape using materials such as structural materials such as frames for skeletons, panels, and exterior materials such as opening/closing doors.

The housing 10 in the first exemplary embodiment is configured as a housing of which the external shape is approximately a rectangular parallelepiped.

The housing 10 has left and right side surfaces (left side surface 11 and right side surface 12) forming both left and right ends thereof when viewed from the front or a front surface facing a user of the image forming apparatus 1. In addition, a discharge sheet accommodation unit 13 is provided at an upper end portion of the housing 10. The discharge sheet accommodation unit 13 is formed as a structural part having an accommodation slope 13a that slopes downward to the left side from the right side of the upper end of the housing 10 in FIG. 1.

The image forming unit 2 is a part that is arranged inside the housing 10 and forms an image on the sheet 9.

The image forming unit 2 in the first exemplary embodiment adopts an electrophotographic method, and is configured as a part that forms an unfixed image using the electrophotographic method, and then transfers and fixes the unfixed image onto the sheet 9.

Specifically, as illustrated in FIG. 2, the image forming unit 2 includes an imaging unit 20 that creates an image (toner image) consisting of dry developer, an intermediate transfer unit 30 that temporarily holds the image created by the imaging unit 20 and transfers the image onto the sheet 9, and a fixing unit 38 that fixes an unfixed image transferred onto the sheet 9, onto the sheet 9.

The imaging unit 20 includes four imaging units 20Y, 20M, 20C, and 20K which independently form toner images consisting of four colors of, for example, yellow (Y), magenta (M), cyan (C), and black (K).

In addition, the imaging units 20Y, 20M, 20C, and 20K are arranged in series at regular intervals from the right side to the left side inside the housing 10.

The imaging units 20Y, 20M, 20C, and 20K are configured in approximately the same manner except that colors of the developers used are different from each other.

That is, as a representative example of the imaging unit 20K in FIG. 2, the imaging units 20Y, 20M, 20C, and 20K are configured as units including a photosensitive drum 21, a charging device 22, an image exposure device 23, a developing device 24, a primary transfer roll 25 as a primary transfer device, a drum cleaning device 26, and the like.

In FIG. 2, only the reference numerals of the photosensitive drums 21 and the developing devices 24 (Y, M, and C) are described for the imaging units 20 (Y, M, and C) other than the imaging unit 20K, and other reference numerals are omitted without being described.

In the imaging units 20Y, 20M, 20C, and 20K, toner images consisting of the four colors described above are respectively formed as necessary in a case of an image forming operation.

Using the imaging unit 20K as a representative example, first, the photosensitive drum 21 rotates in a direction of an arrow illustrated in FIG. 2, and an outer peripheral surface (image forming surface) of the photosensitive drum 21 is charged to have a uniform surface potential by the charging device 22. Thereafter, exposure based on the image information is performed by the image exposure device 23, and an electrostatic latent image is formed on the charged outer peripheral surface of the photosensitive drum 21. Subsequently, in the imaging unit 20K, the electrostatic latent image on the photosensitive drum 21 is developed with the black toner supplied from the developing device 24K, and a black toner image is formed on the photosensitive drum 21.

Regarding the primary transfer device, in a case where the image forming apparatus 1 adopts the intermediate transfer unit 30, the primary transfer roll 25 is adopted as a primary contact transfer member, and is treated as a part constituting the intermediate transfer unit 30.

As illustrated in FIG. 2, the intermediate transfer unit 30 is configured as a unit including a support frame (not illustrated), an intermediate transfer belt 31, belt holding rolls 32, 33, 34, and 35, primary transfer rolls 25, a secondary transfer device 36, a belt cleaning device 37, and the like.

In addition, the intermediate transfer unit 30 is arranged above the imaging units 20Y, 20M, 20C, and 20K inside the housing 10.

In the intermediate transfer unit 30, each position where the outer peripheral surface of the intermediate transfer belt 31 pushed by the primary transfer roll 25 is in contact with each photosensitive drum 21 in the imaging units 20Y, 20M, 20C, and 20K is a primary transfer position.

In addition, in the intermediate transfer unit 30, a position where a secondary contact transfer member (secondary transfer roll) of the secondary transfer device 36 is in contact with the outer peripheral surface of the intermediate transfer belt 31 is a secondary transfer position.

In the intermediate transfer unit 30, in a case of the image forming operation, first, the intermediate transfer belt 31 rotates in a direction indicated by arrows of FIG. 2, and then, the toner image formed on all or a part of the imaging units 20Y, 20M, 20C, and 20K is primarily transferred onto the outer peripheral surface of the intermediate transfer belt 31 under the transfer action of the primary transfer roll 25 at the primary transfer position. Subsequently, in the intermediate transfer unit 30, the toner image that has been primarily transferred onto the outer peripheral surface of the intermediate transfer belt 31 is secondarily transferred onto the sheet 9 supplied from the sheet tray 4, the manual feed tray 5, or the like under the transfer action of the secondary transfer device 36, at the secondary transfer position.

The fixing unit 38 is a unit that fixes the toner image that has been secondarily transferred onto the sheet 9 at the secondary transfer position of the intermediate transfer unit 30, onto the sheet 9.

Therefore, the fixing unit 38 is arranged at a position above the secondary transfer position of the intermediate transfer unit 30 inside the housing 10.

As illustrated in FIG. 2, the fixing unit 38 is configured as a unit including a unit housing 38a, a heating rotation member 38b consisting of a roll form, a belt form, or the like, and a pressurization rotation member 38c consisting of a roll form, a belt form, or the like.

In addition, the fixing unit 38 has a contact portion (fixing processing unit) that brings the heating rotation member 38b and the pressurization rotation member 38c into contact approximately along a direction of a rotation axis.

In the fixing unit 38, in a case of the image forming operation, the sheet 9 onto which the toner image is secondarily transferred in the intermediate transfer unit 30 is introduced into and passes through the contact portion. In this manner, the fixing unit 38 fixes the unfixed toner image on the sheet 9 by heating and melting the unfixed toner image under the pressure.

The sheet tray 4 is a structure that accommodates the sheet 9 on which an image is to be formed and that supplies the sheet 9 to the image forming unit 2.

In the first exemplary embodiment, three sheet trays 4A, 4B, and 4C consisting of a first sheet tray 4A, a second sheet tray 4B, and a third sheet tray 4C are adopted as the sheet tray 4.

The three sheet trays 4A, 4B, and 4C are configured as the first sheet tray 4A, the second sheet tray 4B, and the third sheet tray 4C that are arranged at intervals in an up-down direction inside the housing 10.

Specifically, the first sheet tray 4A is arranged at the top position, the second sheet tray 4B is arranged at a middle position below the first sheet tray 4A, and the third sheet tray 4C is arranged at the bottom position below the second sheet tray 4B.

In addition, the three sheet trays 4A, 4B, and 4C are attached to the housing 10 in such a manner that the sheet tray can be pulled out and held to the front side (front side of the paper in FIG. 1) from the front of the housing 10.

Furthermore, each of the sheet trays 4A, 4B, and 4C includes a tray body 41, a feeding device 42, and the like.

The tray body 41 is a structure that accommodates the sheets 9 with a required size such that the sheets 9 are stacked in a landscape orientation or a portrait orientation. More specifically, the tray body 41 is a box-shaped structure in which a loading plate (not illustrated) or the like is arranged, and of which the upper side is open.

In addition, a pair of left and right movement support portions 49A and 49B that support each movement of the tray body 41 to the front side and the back side in the image forming apparatus 1, inside the housing 10 is provided on the left and right side surface portions of the tray body 41. The movement support portions 49A and 49B are configured by slide rails or the like provided in a paired relationship with the housing 10, for example.

Hereinafter, regarding the tray body 41, the tray body 41 in the first sheet tray 4A is referred to as a first tray body 41A, the tray body 41 in the second sheet tray 4B is referred to as a second tray body 41B, and the tray body 41 in the third sheet tray 4C is referred to as a third tray body 41C.

In addition, regarding the sheet 9, the sheet 9 accommodated in the first sheet tray 4A is referred to as a sheet 9A, the sheet 9 accommodated in the second sheet tray 4B is referred to as a sheet 9B, and the sheet 9 accommodated in the third sheet tray 4C is referred to as a sheet 9C.

The sheet 9 is one on which an image consisting of the developer can be formed. In addition, the sheet 9 includes a type of medium such as coated paper and resin sheet, other than pulp paper.

The feeding device 42 is a device that feeds the sheet 9 one by one to an upper left end portion of the tray body 41 in a left-right direction.

In addition, each of the feeding devices 42 includes a pickup roll 43, a drive feed roll 44, and a conveyance stop roll 45.

The pickup roll 43 is a roll that moves downward during the paper feeding to come into contact with the uppermost sheet 9 in the tray body 41 and that is driven to rotate for taking out the sheet 9 in a feeding direction. The drive feed roll 44 is a roll that is driven to rotate for conveying the sheet 9, which has been taken out from the pickup roll 43, in the feeding direction. The conveyance stop roll 45 is a roll functioning to prevent the conveyance of excess sheets 9 below except for the uppermost sheet 9 in a case where the sheets 9 conveyed by the drive feed roll 44 overlap, and is sometimes called a retard roll, for example.

Hereinafter, regarding the feeding device 42, the feeding device 42 arranged in the first sheet tray 4A is referred to as a first feeding device 42A, the feeding device 42 arranged in the second sheet tray 4B is referred to as a second feeding device 42B, and the feeding device 42 arranged in the third sheet tray 4C is referred to as a third feeding device 42C.

The manual feed tray 5 is a plate-shaped structure for accommodating a desired sheet 9 from outside the housing 10 at a desired timing and using the sheet 9 for image formation.

Hereinafter, the sheet 9 accommodated in the manual feed tray 5 is referred to as a sheet 9D.

The manual feed tray 5 is arranged to protrude from the left side surface 11 that is one side surface of the housing 10.

In addition, the manual feed tray 5 includes a tray body 51 that has an accommodation surface 51a where the sheets 9D are accommodated, a manual feeding device 53 that feeds the uppermost sheet 9 of the sheets 9D accommodated in the tray body 51, and the like.

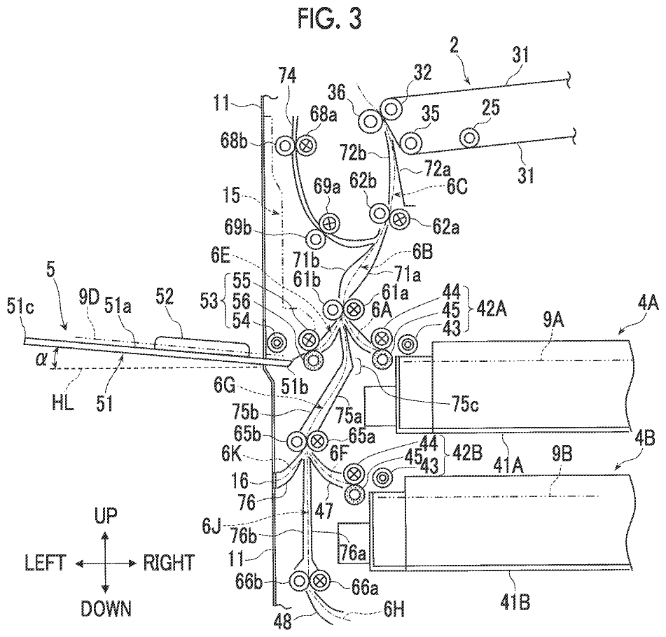

As illustrated in FIG. 3, the tray body 51 is a plate-shaped structure.

As illustrated in FIG. 1, the tray body 51 is attached to a part of the left side surface 11 in a state of protruding from the left side surface 11 of the housing 10 by a predetermined length (horizontal width in the left-right direction: W2). The horizontal width W2 of the tray body 51 is a separation distance in a horizontal direction between a protruding end portion (distal end portion) 51C of the tray body 51 and the left side surface 11 of the housing 10.

In addition, as illustrated in FIG. 3, the tray body 51 is attached such that an inclination angle α of the accommodation surface 51a with respect to a horizontal line HL is within a range of 5°<α≤8°. In a case where the inclination angle α is equal to or less than 5°, there is a risk that the trailing edge side of the sheets 9D accommodated in the manual feed tray 5 may hang down or the sheets 9D may fall, for example.

Furthermore, the tray body 51 is provided with a pair of guide plates 52 that guides the sheet 9D accommodated in the accommodation surface 51a such that the left and right ends of the sheet 9D are aligned in a case of feeding the sheet 9D, at both left and right end portions of the feeding direction of the sheet 9D. The pair of guide plates 52 is provided in a state where the pair of guide plates 52 is arbitrarily moved inward from both the left and right end portions of the tray body 51 to adjust the guide position.

The manual feeding device 53 includes a pickup roll 54, a drive feed roll 55, and a conveyance stop roll 56 approximately similar to the case of the feeding device 42 in the sheet tray 4.

The pickup roll 54 is a roll that moves downward during the paper feeding to come into contact with the uppermost sheet 9D accommodated in the tray body 51 and that is driven to rotate for taking out the sheet 9D in the feeding direction. The drive feed roll 55 is a roll that is driven to rotate for conveying the sheet 9D, which has been taken out from the pickup roll 54, in the feeding direction. The conveyance stop roll 56 is a roll functioning to prevent the conveyance of excess sheets 9D below except for the uppermost sheet 9D in a case where the sheets 9D conveyed by the drive feed roll 55 overlap.

In addition, the manual feeding device 53 is arranged in a state where the pickup roll 54, the drive feed roll 55, and the conveyance stop roll 56 are present inside the housing 10.

In other words, the manual feeding device 53 in this case is arranged to be present on the inner side of the left side surface 11 of the housing 10, or is arranged in a state of not protruding outward from the left side surface 11.

In addition, the manual feed tray 5 in this case is arranged such that one end portion 51b of the tray body 51 on the attachment side (strictly, the attachment-side end portion of the accommodation surface 51a) is present inside the housing 10.

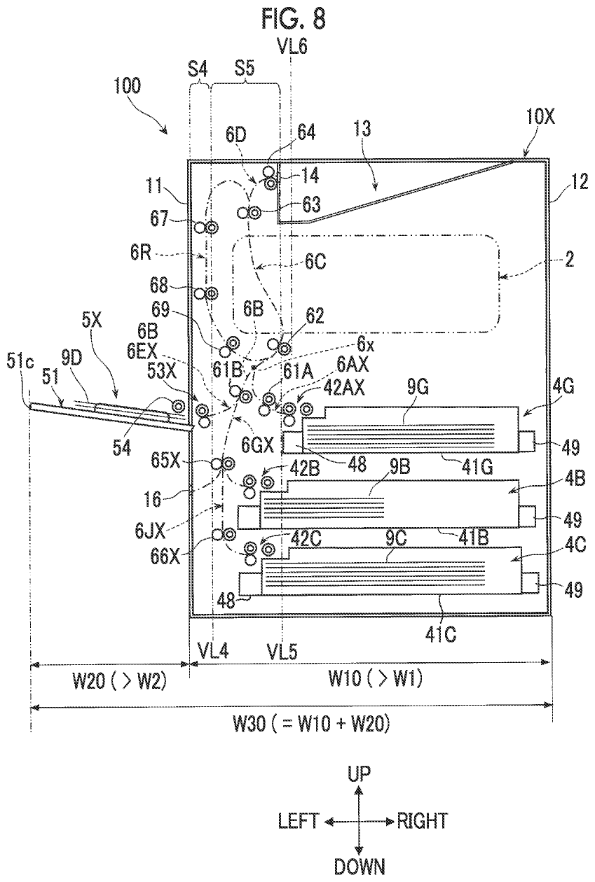

In this manner, in a case where the tray body 51 has the same size, in the image forming apparatus 1, as illustrated in FIG. 1, the left and right width W2 including the manual feed tray 5 of the image forming apparatus 1 may be narrowed as compared to an image forming apparatus 100 as a comparison target in which a part (for example, pickup roll 54) of a manual feeding device 53X of a manual feed tray 5X is arranged to be exposed to the outside of a housing 10X as exemplified in FIG. 8.

On the other hand, in the image forming apparatus 100 as the comparison target, since a part of the manual feeding device 53X is arranged to be exposed to the outside of the housing 10X, the tray body 51 of the manual feed tray 5X has to be arranged by being shifted to protrude to the outside of the housing 10X by the amount of the part of the manual feeding device 53X protruding and being exposed from the left side surface 11 of the housing 10X.

Furthermore, the manual feed tray 5 is configured such that the tray body 51 is stored in a storage space 15 (refer to FIG. 3), which is provided in a recessed shape on the left side surface 11 of the housing 10, in a case where the manual feed tray 5 is not used.

Specifically, the manual feed tray 5 is attached such that the tray body 51 can be rotatable in a direction approaching the left side surface 11 using, for example, a support shaft (not illustrated) in the vicinity of the one end portion 51b, which is positioned inside the housing 10, of the tray body 51, as a fulcrum.

In addition, the manual feeding device 53 is designed to be accommodated inside the housing 10 in a manner that the pickup roll 54 rotates together with the tray body 51 using, for example, the rotation axis of the drive feed roll 55 as a fulcrum in a case where the tray body 51 is stored in the storage space 15.

### Configuration of Conveyance Path of Sheet

As illustrated in FIG. 1 and the like, in the image forming apparatus 1, an adjustment conveyance roll pair 62 is provided inside the housing 10.

The adjustment conveyance roll pair 62 is one pair of rolls that conveys the sheet 9 fed from the first sheet tray 4A or the like, by adjusting a timing and a conveyance posture to feed the sheet 9 to the image forming unit 2.

As illustrated in FIG. 3 or the like, the adjustment conveyance roll pair 62 is a pair of rolls in which a drive adjustment roll 62a and a driven adjustment roll 62b are combined.

In the drive adjustment roll 62a, a plurality of roll bodies are fixed at intervals to the rotation axis that is rotatably supported. The drive adjustment roll 62a is driven to rotate by rotational power transmitted from a drive device (not illustrated) to the rotation axis. In the driven adjustment roll 62b, a plurality of roll bodies are fixed at intervals to the rotation axis that is rotatably supported. The driven adjustment roll 62b rotates as a result of the roll bodies thereof contacting the rotating roll bodies of the drive adjustment roll 62a with a predetermined pressure.

In a case of the image forming operation, the adjustment conveyance roll pair 62 in the first exemplary embodiment temporarily stops the sheet 9 fed from the first sheet tray 4A or the like, corrects the conveyance posture of the sheet 9, and then starts rotating in time with the image forming timing (actually, the secondary transfer timing) to feed the sheet 9.

In addition, the adjustment conveyance roll pair 62 is arranged between the image forming unit 2 and the first sheet tray 4A.

Furthermore, as illustrated in FIG. 3 or the like, the adjustment conveyance roll pair 62 is arranged such that the drive adjustment roll 62a is present further away from the left side surface 11 of the housing 10 than the driven adjustment roll 62b.

In addition, in the image forming apparatus 1, as illustrated in FIG. 1, a supply conveyance path 6B, an image forming conveyance path 6C, and a discharge conveyance path 6D are provided inside the housing 10.

The supply conveyance path 6B is a conveyance path along which the sheet 9 is conveyed to be supplied to the adjustment conveyance roll pair 62.

The supply conveyance path 6B is configured by a pair of first sheet guide members 71a and 71b arranged between the adjustment conveyance roll pair 62 and a common conveyance roll pair 61 which will be described later. The first sheet guide members 71a and 71b are arranged to form a desired conveyance space therebetween, through which the sheet 9 to be conveyed passes while being guided up to the adjustment conveyance roll pair 62 as a conveyance destination.

The image forming conveyance path 6C is a conveyance path through which the sheet 9 is conveyed from the adjustment conveyance roll pair 62 until the image formation of the image forming unit 2 ends.

The image forming conveyance path 6C in the first exemplary embodiment has a first conveyance path that is from the adjustment conveyance roll pair 62 to a start position of the image formation of the image forming unit 2, and a second conveyance path that is from the start position to an end position of the image formation.

The start position of the image formation is the secondary transfer position in the intermediate transfer unit 30. In addition, the end position of the image formation is a position (fixation position) as the contact portion of the fixing unit 38.

As illustrated in FIG. 3, the first conveyance path of the image forming conveyance path 6C is configured by a pair of second sheet guide members 72a and 72b arranged between the adjustment conveyance roll pair 62 and the secondary transfer position in the image forming unit 2. The second sheet guide members 72a and 72b are arranged to form a desired conveyance space therebetween, through which the sheet 9 to be conveyed passes while being guided up to the secondary transfer position as the conveyance destination.

As illustrated in FIG. 2, the second conveyance path of the image forming conveyance path 6C is configured by a third sheet guide member 73 arranged between the secondary transfer position in the image forming unit 2 and the fixation position in the image forming unit 2. The third sheet guide member 73 is arranged to be able to guide the sheet 9 that has passed through the secondary transfer position, into the contact portion of the fixing unit 38. The third sheet guide member 73 is arranged to guide the sheet 9 from a surface on a side opposite to the surface of the sheet 9 where the toner image is transferred.

The discharge conveyance path 6D is a conveyance path through which the sheet 9 on which the image has been formed is conveyed up to a discharge port 14 that is provided on the side surface of the discharge sheet accommodation unit 13.

The discharge conveyance path 6D is configured by a plurality of conveyance roll pairs 63 and 64 arranged between the image forming unit 2 and the discharge port 14, and a sheet guide member (not illustrated). The conveyance roll pair 63 is arranged at a position past the fixing unit 38, for example. In addition, the conveyance roll pair 64 is arranged as a discharge roll pair at a position close to the discharge port 14, for example.

In addition, in the image forming apparatus 1, as illustrated in FIG. 1, a reversal retransmission conveyance path 6R is provided inside the housing 10.

The reversal retransmission conveyance path 6R is a conveyance path through which the sheet 9, which has passed through the image forming conveyance path 6C and of which the image has been formed on the one surface, is joined at a middle position of the supply conveyance path 6B while being turned upside down, and then is retransmitted to the supply conveyance path 6B. The reversal retransmission conveyance path 6R is referred to as a double-sided image forming conveyance path, for example.

As illustrated in FIG. 1, the reversal retransmission conveyance path 6R is configured by a plurality of conveyance roll pairs 67, 68, and 69, a pair of sheet guide members 74 (refer to FIG. 3), a sheet path switching member (not illustrated), and the like.

Furthermore, in the image forming apparatus 1, as illustrated in FIG. 3, a first relay conveyance path 6G and a second relay conveyance path 6J are provided inside the housing 10.

The first relay conveyance path 6G is, in principle, a conveyance path through which the sheet 9B or the like fed from the second sheet tray 4B or the like is conveyed up to the supply conveyance path 6B. Specifically, the first relay conveyance path 6G is a conveyance path through which the sheet 9 is conveyed from a first relay conveyance roll pair 65, which will be described later, up to the common conveyance roll pair 61, which will be described later.

The first relay conveyance path 6G is configured by the first relay conveyance roll pair 65 and a pair of fourth sheet guide members 75a and 75b.

As illustrated in FIG. 3 or the like, the first relay conveyance roll pair 65 is a pair of rolls in which a drive conveyance roll 65a and a driven conveyance roll 65b are combined.

In the drive conveyance roll 65a, a plurality of roll bodies are fixed at intervals to the rotation axis that is rotatably supported. The drive conveyance roll 65a is driven to rotate by rotational power transmitted from a drive device (not illustrated) to the rotation axis. In the driven conveyance roll 65b, a plurality of roll bodies are fixed at intervals to the rotation axis that is rotatably supported. The driven conveyance roll 65b rotates as a result of the roll bodies thereof contacting the rotating roll bodies of the drive conveyance roll 65a with a predetermined pressure.

In addition, as illustrated in FIG. 3 or the like, the first relay conveyance roll pair 65 is arranged at a position that is below the common conveyance roll pair 61 described later and that is shifted to a side closer to the left side surface 11 of the housing 10 than the common conveyance roll pair 61 and the second feeding device 42B.

Furthermore, the first relay conveyance roll pair 65 is arranged such that the axial center of the drive conveyance roll 65a and the axial center of the driven conveyance roll 65b are at approximately the same height in the up-down direction, and are lined up in the left and right horizontal direction. Moreover, the first relay conveyance roll pair 65 is arranged such that the drive conveyance roll 65a is present further away from the left side surface 11 of the housing 10 than the driven conveyance roll 65b.

The fourth sheet guide members 75a and 75b are arranged to form a conveyance space consisting of a desired shape therebetween, through which the sheet 9B to be conveyed passes while being guided up to the common conveyance roll pair 61, which will be described later, as a relay destination.

Details of the fourth sheet guide members 75a and 75b will be described later.

The second relay conveyance path 6J is a conveyance path through which the sheet 9C or the like fed from the third sheet tray 4C or the like is relayed and conveyed up to the first relay conveyance path 6G. Specifically, the second relay conveyance path 6J is a conveyance path through which the sheet 9C is conveyed from a second relay conveyance roll pair 66, which will be described later, up to the first relay conveyance roll pair 65.

The second relay conveyance path 6J is configured by the second relay conveyance roll pair 66 and a pair of fifth sheet guide members 76a and 76b.

As illustrated in FIG. 3 or the like, similar to the first relay conveyance roll pair 65, the second relay conveyance roll pair 66 is a pair of rolls in which a drive conveyance roll 66a and a driven conveyance roll 66b are combined.

The fifth sheet guide members 76a and 76b are arranged to form a conveyance space consisting of a shape extending approximately straight in the up-down direction therebetween, such that the sheet 9C to be conveyed passes through the fifth sheet guide members 76a and 76b while being guided up to the first relay conveyance roll pair 65 as the relay destination.

### Configuration of Conveyance System of First Sheet Tray, Manual Feed Tray, and Sheet

As illustrated in FIG. 3 or the like, the first sheet tray 4A in the image forming apparatus 1 is arranged such that the first tray body 41A faces one end portion (one end portion 51b of the tray body 51) of the manual feed tray 5 inside the housing 10 so that at least a part of the first tray body 41A overlaps the one end portion in the up-down direction along a gravity direction.

The first sheet tray 4A in the first exemplary embodiment is arranged such that the upper side surface portion of the left side end portion of the first tray body 41A faces the one end portion 51b of the tray body 51, which is one end portion of the manual feed tray 5, so that the upper side surface portion overlaps the one end portion 51b in the up-down direction.

In addition, as illustrated in FIG. 3, the first feeding device 42A and the manual feeding device 53 in the first exemplary embodiment are arranged such that the drive feed roll 44 and the conveyance stop roll 45 of the first feeding device 42A and the drive feed roll 55 and the conveyance stop roll 56 of the manual feeding device 53 face each other at approximately the same height in the up-down direction.

Furthermore, the manual feed tray 5 in the image forming apparatus 1 is arranged in a state where the pickup roll 54, the drive feed roll 55, and the conveyance stop roll 56 are present inside the housing 10 as described above.

Even in the image forming apparatus 1 having such a prerequisite configuration, the first sheet tray 4A may be a tray that can accommodate A3 size sheets in a landscape orientation. The landscape orientation is an accommodation mode in which the sheet 9 is placed in a state where the long side of the sheet 9 is along the conveyance direction.

Therefore, the first sheet tray 4A is required to secure a dimension that allows A3 size sheets to be placed in a landscape orientation, as the length of the first tray body 41A in the left-right direction.

In addition, in order to secure the dimension while also avoiding an increase in a left and right width W1 (refer to FIG. 1) of the housing 10, the first feeding device 42A of the first sheet tray 4A needs to be arranged as close as possible to the manual feeding device 53 of the manual feed tray 5.

Due to such a circumstance, in the image forming apparatus 1, as illustrated in FIGS. 1, 3, and the like, the first feeding device 42A of the first sheet tray 4A and the manual feeding device 53 of the manual feed tray 5 cannot be arranged with a wide interval in the left and right horizontal direction, and thus have to be arranged close to each other.

Thus, in the image forming apparatus 1, as illustrated in FIGS. 1, 3, and the like, the common conveyance roll pair 61 is provided which first receives and conveys both the sheet 9A fed from the first feeding device 42A of the first sheet tray 4A and the sheet 9D fed from the manual feeding device 53 of the manual feed tray 5.

As illustrated in FIG. 3 or the like, the common conveyance roll pair 61 is a pair of rolls in which a drive conveyance roll 61a and a driven conveyance roll 61b are combined.

In the drive conveyance roll 61a, a plurality of roll bodies are fixed at intervals to the rotation axis that is rotatably supported. The drive conveyance roll 61a is driven to rotate by rotational power transmitted from a drive device (not illustrated) to the rotation axis. In the driven conveyance roll 61b, a plurality of roll bodies are fixed at intervals to the rotation axis that is rotatably supported. The driven conveyance roll 61b rotates as a result of the roll bodies thereof contacting the rotating roll bodies of the drive conveyance roll 61a with a predetermined pressure.

In addition, as illustrated in FIG. 3 or the like, the common conveyance roll pair 61 is arranged such that the drive conveyance roll 61a is present further away from the left side surface 11 of the housing 10 than the driven conveyance roll 61b in the left and right horizontal direction. The common conveyance roll pair 61 in this case is arranged such that the center of the drive conveyance roll 61a and the center of the driven conveyance roll 61b are at approximately the same height in the up-down direction, and are lined up horizontally in the left and right horizontal direction.

Furthermore, the common conveyance roll pair 61 is arranged between the manual feeding device 53 and the first feeding device 42A, at a position which is diagonally upwardly away from both the manual feeding device 53 and the first feeding device 42A and at which the conveyance paths are joined.

The common conveyance roll pair 61 in the first exemplary embodiment is arranged at a position (the contact portion of the rolls) that is the apex of an isosceles triangle having the base, for example, in a case of assuming that a straight line connecting the drive feed roll 55 of the manual feeding device 53 and the drive feed roll 44 of the first feeding device 42A is the base.

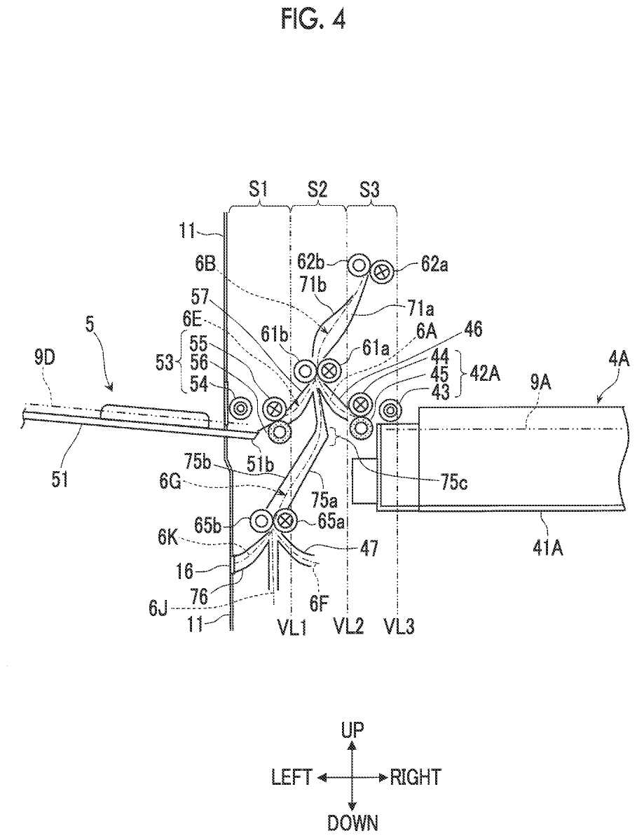

In addition, in the image forming apparatus 1, as illustrated in FIGS. 3, 4, and the like, the first feeding device 42A is arranged at a position close to the manual feeding device 53 to leave a distance corresponding to the left and right width of the common conveyance roll pair 61. Here, the left and right width is a dimension that is the sum of a roll diameter of the drive conveyance roll 61a and a roll diameter of the driven conveyance roll 61b.

Moreover, in the image forming apparatus 1, as illustrated in FIGS. 3, 4, and the like, it can be said that the first feeding device 42A is arranged at a position adjacent to the common conveyance roll pair 61 on a side further away from the left side surface 11 of the housing 10 than a position directly below the common conveyance roll pair 61.

Therefore, as illustrated in FIG. 4, the common conveyance roll pair 61 in the image forming apparatus 1 is arranged in a separation region S2 sandwiched between a two-dot chain line VL1, which passes through the right end of the manual feeding device 53 and extends in the up-down direction, and a two-dot chain line VL2, which passes through the left end of the first feeding device 42A and extends in the up-down direction, with few gaps on both the left and right sides.

In addition, in the image forming apparatus 1, as illustrated in FIG. 3 or the like, a first feeding conveyance path 6A is provided from the first feeding device 42A of the first sheet tray 4A to the common conveyance roll pair 61.

The first feeding conveyance path 6A is a conveyance path forming a conveyance route that extends diagonally to the upper left side while slightly being bent such that the sheet 9A fed from the first feeding device 42A is conveyed toward a roll contact portion (nip portion) where the rolls of the common conveyance roll pair 61 are in contact with each other.

As illustrated in FIG. 4, the first feeding conveyance path 6A is configured by a pair of sheet guide members 46 arranged between the first feeding device 42A and the common conveyance roll pair 61.

The pair of sheet guide members 46 is arranged to form a conveyance space with a shape extending diagonally upward while being bent toward the roll contact portion of the common conveyance roll pair 61 therebetween in order to guide and pass the sheet to the common conveyance roll pair 61 as a feeding destination.

In addition, in the image forming apparatus 1, as illustrated in FIG. 3 or the like, a manual feeding conveyance path 6E is provided from the manual feeding device 53 of the manual feed tray 5 up to the common conveyance roll pair 61.

The manual feeding conveyance path 6E is a conveyance path that is a conveyance route that extends diagonally to the upper right side while slightly being bent such that the sheet 9D fed from the manual feeding device 53 is conveyed toward the roll contact portion of the common conveyance roll pair 61.

As illustrated in FIG. 4, the manual feeding conveyance path 6E is configured by a pair of sheet guide members 57 arranged between the manual feeding device 53 and the common conveyance roll pair 61.

The pair of sheet guide members 57 is arranged to form a conveyance space with a shape extending diagonally upward while being bent toward the roll contact portion of the common conveyance roll pair 61 therebetween in order to guide and pass the sheet to the common conveyance roll pair 61 as a feeding destination.

As illustrated in FIG. 3 or the like, the common conveyance roll pair 61 constitutes a point on a conveyance start side of the supply conveyance path 6B.

Therefore, in the image forming apparatus 1, both the sheet 9A fed from the first feeding device 42A and the sheet 9D fed from the manual feeding device 53 first commonly pass through one common conveyance roll pair 61, and then are conveyed to the adjustment conveyance roll pair 62 through the supply conveyance path 6B.

Specifically, the sheet 9A fed from the first feeding device 42A is first received by the common conveyance roll pair 61 through the first feeding conveyance path 6A, and then is conveyed up to the adjustment conveyance roll pair 62 through the supply conveyance path 6B by conveying force of the common conveyance roll pair 61.

In addition, the sheet 9D fed from the manual feeding device 53 is first received by the common conveyance roll pair 61 through the manual feeding conveyance path 6E, and then is conveyed to the adjustment conveyance roll pair 62 through the supply conveyance path 6B by the conveying force of the common conveyance roll pair 61.

As described above, in the image forming apparatus 1, the left and right width W1 of the housing 10 illustrated in FIG. 1 may be narrowed as compared with a case of the image forming apparatus 100 as the comparison target exemplified in FIG. 8.

The image forming apparatus 100 as the comparison target in this case is an image forming apparatus having a configuration in which an internal conveyance roll pair 61A that first receives and conveys a sheet 9G that has been fed from a first feeding device 42AX, and a manual conveyance roll pair 61B that first receives and conveys the sheet 9D that has been fed from the manual feeding device 53X are individually provided, as illustrated in FIG. 8.

In addition, a left and right width W10 in this case is a dimension in which the leftmost portion of the left side surface 11 and the rightmost portion of the right side surface 12 are separated in the left and right horizontal direction.

Specifically, in the image forming apparatus 100 as the comparison target, as illustrated in FIG. 8, it is necessary to arrange two conveyance roll pairs of the internal conveyance roll pair 61A and the manual conveyance roll pair 61B, and to arrange an eleventh conveyance path 6AX and a twelfth conveyance path 6EX which respectively pass through the internal conveyance roll pair 61A and the manual conveyance roll pair 61B.

Therefore, in the image forming apparatus 100, the width of a separation region S5 between the first feeding device 42AX of a first sheet tray 4G and the manual feeding device 53X of the manual feed tray 5X in the left-right direction is increased by the amount of arranging the two conveyance roll pairs, the eleventh conveyance path 6AX, and the twelfth conveyance path 6EX in the separation region S5.

A two-dot chain line VL4 in FIG. 8 is a virtual straight line that passes through the right end of the manual feeding device 53X and extends in the up-down direction. In addition, a two-dot chain line VL5 is a virtual straight line that passes through the left end of the first feeding device 42AX and extends in the up-down direction. A two-dot chain line VL6 is a virtual straight line that passes through the right end of the adjustment conveyance roll pair 62 and extends in the up-down direction.

In addition, the eleventh conveyance path 6AX is a conveyance path that extends from the first feeding device 42AX to pass through the internal conveyance roll pair 61A and join the supply conveyance path 6B at a joining point 6x. The twelfth conveyance path 6EX is a conveyance path from the manual feeding device 53X to the manual conveyance roll pair 61B.

Furthermore, the supply conveyance path 6B in the image forming apparatus 100 is a conveyance path from the manual conveyance roll pair 61B up to the adjustment conveyance roll pair 62. In addition, in the image forming apparatus 100, a first relay conveyance path 6GX extending from a first relay conveyance roll pair 65X is arranged to reach the manual conveyance roll pair 61B.

On the other hand, in the image forming apparatus 1, as illustrated in FIG. 4, since it is sufficient to arrange one common conveyance roll pair 61 in the separation region S2, the width of the separation region S2 between the first feeding device 42A and the manual feeding device 53 in the left-right direction becomes narrower by at least that amount.

Accordingly, in the image forming apparatus 1, the width of the separation region S2 becomes narrower than the width of the separation region S5 in the image forming apparatus 100 as the comparison target, and at least the left and right width W1 of the housing 10 also becomes narrower than the left and right width W10 of the housing 10X of the image forming apparatus 100 as the comparison target (W1<W10).

A two-dot chain line VL3 in FIG. 4 is a virtual straight line that passes through the right end of the adjustment conveyance roll pair 62 and extends in the up-down direction.

Incidentally, the adjustment conveyance roll pair 62 is arranged to be present in a region S3 sandwiched between the two-dot chain line VL2 and the two-dot chain line VL3.

In addition, the adjustment conveyance roll pair 62 is arranged such that the right end (two-dot chain line VL3) thereof is present at a position shifted to the right side of the left end (two-dot chain line VL2) of the first feeding device 42A. The adjustment conveyance roll pair 62 in the image forming apparatus 100 as the comparison target is also arranged such that the right end (two-dot chain line VL6) thereof is present at a position shifted to the right side of the left end (two-dot chain line VL5) of the first feeding device 42AX (refer to FIG. 8).

Strictly, the image forming apparatus 100 as the comparison target illustrated in FIG. 8 is arranged in a state where a part of the manual feeding device 53X is exposed from the left side surface 11 of the housing 10X.

Therefore, in the image forming apparatus 100, the width of a separation region S4 between the right end of the manual feeding device 53X and the left side surface 11 of the housing 10X in the left-right direction is slightly narrower than the width of a separation region S1 (refer to FIG. 4) between the right end of the manual feeding device 53 and the left side surface 11 of the housing 10 in the left-right direction in the image forming apparatus 1 in which the manual feeding device 53 is arranged to be present inside the housing 10.

However, the amount by which the separation region S4 in the image forming apparatus 100 is narrower than the width of the separation region S1 in the image forming apparatus 1 is smaller than the amount by which the width of the separation region S2 in the image forming apparatus 1 is narrower than the width of the separation region S5 in the image forming apparatus 100. That is, the difference obtained by subtracting the width of the separation region S4 from the width of the separation region S1 is smaller than the difference obtained by subtracting the width of the separation region S2 from the width of the separation region S5.

As a result, in the image forming apparatus 1, in a case where the width of the separation region S1 is slightly wider than the width of the separation region S4 in the image forming apparatus 100, the left and right width W1 of the housing 10 as a whole becomes narrower than the left and right width W10 of the housing 10X of the image forming apparatus 100 (W1<W10).

In addition, with the image forming apparatus 1, A3 size sheets 9 (9A) can be accommodated in the first sheet tray 4A and be used.

In this manner, in the image forming apparatus 1, even in a case where the first sheet tray 4A is configured as a tray which can accommodate A3 size sheets 9, the left and right width W1 of the housing 10 may be narrowed.

In this regard, in a case where the left and right width (W10) of the housing 10X in the image forming apparatus 100 has the same dimension as the left and right width W1 of the housing 10 in the image forming apparatus 1, it is either impossible or technically difficult to configure the first sheet tray 4G as a tray that can accommodate A3 size sheets 9G.

In addition, in the image forming apparatus 1, the manual feeding device 53 and the common conveyance roll pair 61 are arranged close to each other. Therefore, the manual feeding conveyance path 6E in the image forming apparatus 1 is a conveyance route with a bent shape having a smaller curvature than a curvature of the twelfth conveyance path 6EX (refer to FIG. 8) in the image forming apparatus 100 as the comparison target so as to reach the common conveyance roll pair 61 from the manual feeding device 53 in a short distance.

However, in the image forming apparatus 1, the manual feed tray 5 is arranged such that the inclination angle α of the accommodation surface 51a is an angle in a range of 5°<α≤8°.

In addition, in the image forming apparatus 1, as illustrated in FIGS. 3, 4, and the like, the drive feed roll 55 of the manual feeding device 53 is arranged above the conveyance stop roll 56, and is arranged close to the driven conveyance roll 61b of the common conveyance roll pair 61.

In this manner, in the image forming apparatus 1, the curvature of the conveyance route of the manual feeding conveyance path 6E may be made smaller as compared with a case where the inclination angle α of the manual feed tray 5 is set to an angle greater than 8°. As a result, the sheet 9D accommodated in the manual feed tray 5 is conveyed satisfactorily with less conveyance load on the manual feeding conveyance path 6E.

In addition, in the image forming apparatus 1, as compared with a case where the drive feed roll 55 of the manual feeding device 53 is arranged below the conveyance stop roll 56 and is arranged far away from the driven conveyance roll 61b of the common conveyance roll pair 61, the sheet 9D of the manual feed tray 5 receives the winding action during the rotational driving of the drive feed roll 55 in the manual feeding device 53 and is easily conveyed diagonally to the upper right side. As a result, the sheet 9D of the manual feed tray 5 is easily conveyed satisfactorily up to the common conveyance roll pair 61 through the manual feeding conveyance path 6E.

For reference, the sheet 9D of the manual feed tray 5 is fed by the manual feeding device 53, advances such that the leading edge thereof comes into contact with the drive conveyance roll 61a of the common conveyance roll pair 61 present on the right side in a direction of travel, and then begins to be conveyed by being sandwiched between the common conveyance roll pair 61. In addition, the sheet 9D in this case receives the winding action during the rotational driving of the drive conveyance roll 61a in the common conveyance roll pair 61 to be bent to the right side in FIG. 3, and is easily conveyed.

In this manner, the sheet 9D of the manual feed tray 5 is easily conveyed along the supply conveyance path 6B consisting of a conveyance route with a shape bent to the right side in FIG. 3, after passing through the common conveyance roll pair 61.

In addition, in the manual feed tray 5 in the image forming apparatus 1, even in a case where, for example, a thick sheet with a sheet weight of 250 gsm (g/m²) or more is used as the sheet 9D to be accommodated, the thick sheet can be satisfactorily fed to the common conveyance roll pair 61.

In addition, in the image forming apparatus 1, as illustrated in FIG. 3 or the like, the second feeding device 42B of the second sheet tray 4B is arranged at a position shifted to a side closer to the left side surface 11 of the housing 10 than the first feeding device 42A.

Moreover, in the image forming apparatus 1, as illustrated in FIG. 4 or the like, the first relay conveyance roll pair 65 is arranged at a position that is below the common conveyance roll pair 61 and that is shifted to a side closer to the left side surface 11 of the housing 10 than the common conveyance roll pair 61 and the second feeding device 42B.

In this manner, with the image forming apparatus 1, the left and right width W1 of the housing 10 may be narrowed as compared with a case where the first relay conveyance roll pair 65 is arranged at a position that is below the common conveyance roll pair 61 and that is shifted to a side further away from the left side surface 11 of the housing 10 than the common conveyance roll pair 61 and the second feeding device 42B. Moreover, in this case, it is possible to use, as the second sheet tray 4B, a tray of which the length in the left-right direction is longer than the first sheet tray 4A while keeping the left and right width W1 of the housing 10 narrow.

In addition, in the image forming apparatus 1, as illustrated in FIG. 1, the third feeding device 42C of the third sheet tray 4C is also arranged at a position shifted to a side closer to the left side surface 11 of the housing 10 than the first feeding device 42A.

In addition, both the second sheet tray 4B and the third sheet tray 4C are configured as trays which can accommodate A3 size sheets as the sheets 9B and 9C to be respectively accommodated.

Furthermore, as illustrated in FIG. 3, the second relay conveyance roll pair 66 is also arranged at a position that is below the common conveyance roll pair 61 and that is shifted to a side closer to the left side surface 11 of the housing 10 than the common conveyance roll pair 61 and the second feeding device 42B.

In addition, in the image forming apparatus 1, as illustrated in FIG. 3 or the like, the first relay conveyance path 6G is configured as a conveyance path consisting of a conveyance route with a shape that is once bent to protrude in a direction away from the left side surface 11 of the housing 10 and then extends toward the common conveyance roll pair 61 linearly in the up-down direction approximately along the gravity direction.

The first relay conveyance path 6G is configured using the pair of fourth sheet guide members 75a and 75b. That is, the first relay conveyance path 6G is formed using the fourth sheet guide members 75a and 75b to be a conveyance path that extends linearly to the right side in the left-right direction in FIG. 3 or the like, is bent once at a terminal end (upper end) of the extending portion, and then extends toward the common conveyance roll pair 61 linearly in the up-down direction. Reference numeral 75c in FIG. 3 indicates a bent portion in the first relay conveyance path 6G.

In this manner, with the image forming apparatus 1, even in a case where the first relay conveyance path 6G and the common conveyance roll pair 61 are arranged at positions shifted in the left and right horizontal direction, for example, the sheet 9B fed from the second sheet tray 4B is satisfactorily conveyed up to the common conveyance roll pair 61 through the first relay conveyance path 6G.

Specifically, with the image forming apparatus 1, for example, the sheet 9B is satisfactorily conveyed from the first relay conveyance roll pair 65 to the common conveyance roll pair 61 through the first relay conveyance path 6G as compared with a case where the first relay conveyance path 6G is configured as a conveyance path consisting of a conveyance route with a shape extending in a single straight line up to the common conveyance roll pair 61 from the first relay conveyance roll pair 65.

Incidentally, the common conveyance roll pair 61 is a joining point of three conveyance paths of the first feeding conveyance path 6A, the manual feeding conveyance path 6E, and the first relay conveyance path 6G.

Furthermore, in the image forming apparatus 1, since the common conveyance roll pair 61 and the first relay conveyance roll pair 65 are in a shifted positional relationship in the left-right direction, the first relay conveyance path 6G is a bent path starting from the first relay conveyance roll pair 65, being bent once, and then reaching the common conveyance roll pair 61 as described above.

Therefore, in a case of passing through the first relay conveyance path 6G that is once bent and extends, the sheet tends to come into contact with the first relay conveyance path 6G more often during the passage, and is more likely to receive a conveyance resistance as compared with a case where the first relay conveyance path 6G is a linear path.

However, in consideration of a part of the supply conveyance path 6B extending halfway from the common conveyance roll pair 61, the first relay conveyance path 6G in the image forming apparatus 1 forms a path with a shape in which the entire conveyance path is continuous by being bent as an S-shape, as illustrated in FIG. 4.

In this manner, in the image forming apparatus 1, the sheet 9 when being conveyed through the first relay conveyance path 6G becomes more susceptible to the winding action of the drive conveyance roll 65a in the first relay conveyance roll pair 65 to obtain sufficient conveying force, and is satisfactorily conveyed through the first relay conveyance path 6G without giving in to the conveyance resistance.

In addition, even after the sheet 9 reaches the common conveyance roll pair 61, the sheet 9 in this case becomes more susceptible to the winding action of the drive conveyance roll 61a in the common conveyance roll pair 61 to obtain sufficient conveying force, and begins to be satisfactorily conveyed through the supply conveyance path 6B.

### Case of Connecting and Using External Paper Feeding Device

As illustrated in FIG. 1, in the image forming apparatus 1, an external paper feeding device 8 that supplies sheets 9 from outside the housing 10 can be connected and used.

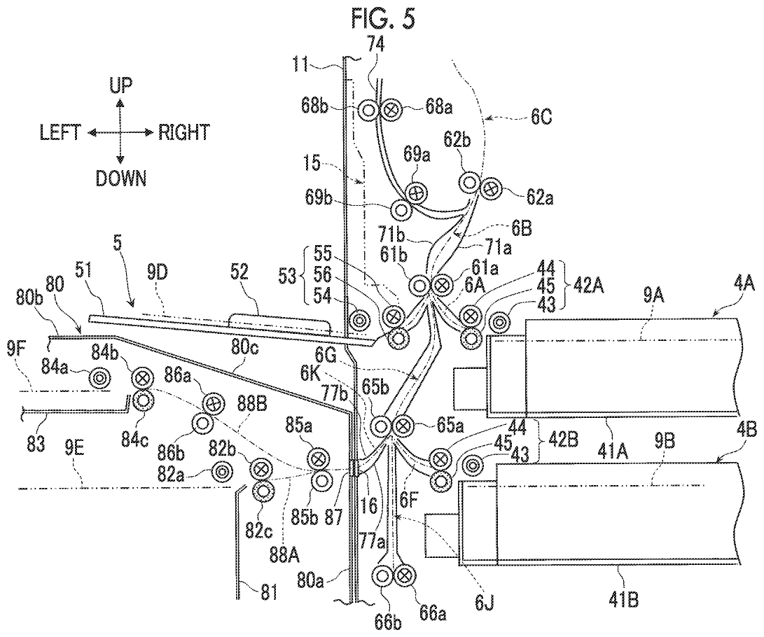

Therefore, as illustrated in FIGS. 3, 5, and the like, since the image forming apparatus 1 can be connected to the external paper feeding device 8, an introduction port 16 for introducing sheets 9 supplied from outside the housing 10 is provided on the left side surface 11 of the housing 10.

The introduction port 16 is provided at a portion of the left side surface 11 facing the second feeding device 42B such that the introduction port 16 at least partially overlaps the second feeding device 42B in the up-down direction along the gravity direction.

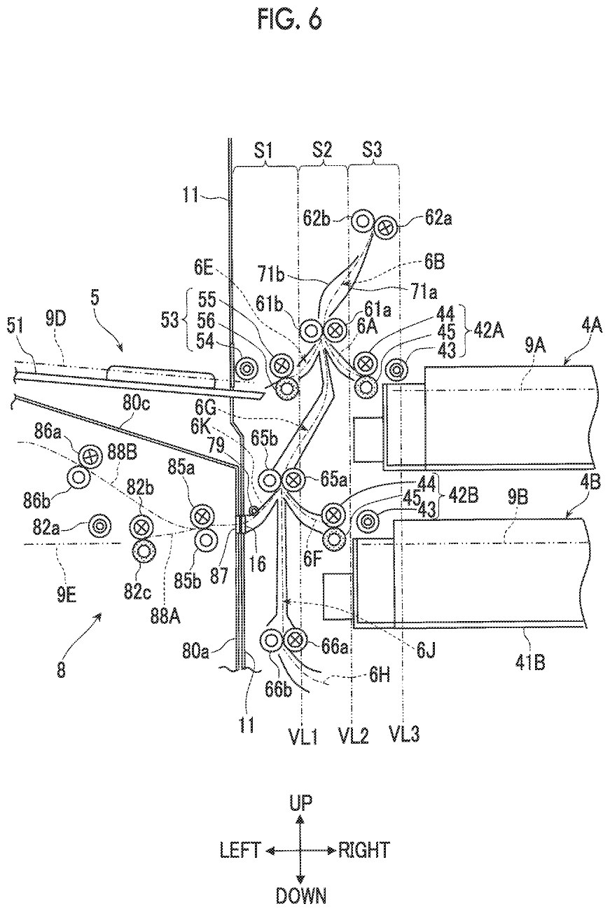

In addition, as illustrated in FIGS. 5, 6, and the like, in the image forming apparatus 1, an introduction conveyance path 6K through which the sheet 9 introduced from the introduction port 16 is guided and conveyed to be first received by the first relay conveyance roll pair 65 is provided inside the housing 10.

As illustrated in FIG. 5 or the like, the introduction conveyance path 6K is configured by a pair of sheet guide members 77a and 77b arranged between the introduction port 16 and the first relay conveyance roll pair 65.

The pair of sheet guide members 77a and 77b is arranged to form a conveyance space with a shape bent diagonally upward therebetween, such that the sheet 9 passes through the pair of sheet guide members 77a and 77b while being guided from the introduction port 16 up to the first relay conveyance roll pair 65.

That is, as illustrated in FIG. 5 or the like, the introduction conveyance path 6K is configured by the pair of sheet guide members 77a and 77b to be a conveyance path consisting of a conveyance route with a bent shape being bent once to protrude in a direction away from the left side surface 11 of the housing 10 and ascending to reach the first relay conveyance roll pair 65.

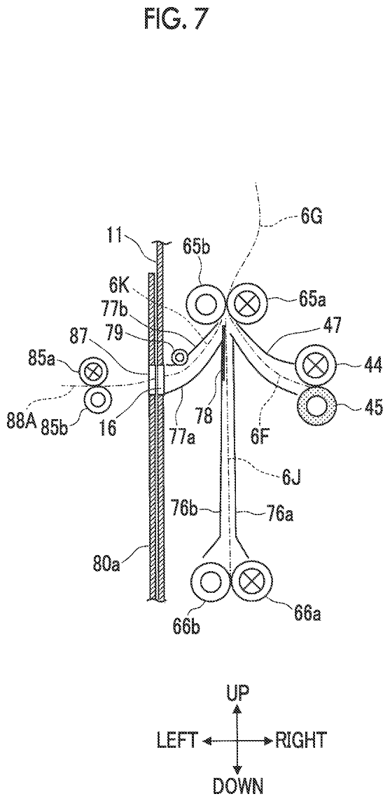

In addition, as illustrated in FIG. 7, a part of the introduction conveyance path 6K before reaching the first relay conveyance roll pair 65 is configured by a flexible sheet 78 that finally guides the sheet 9 (9E, 9F) to the roll contact portion of the first relay conveyance roll pair 65.

The flexible sheet 78 is installed such that a lower end thereof is attached to the upper end side of the fifth sheet guide member 76b constituting the second relay conveyance path 6J, and an upper end (free end) thereof is present at a position before the roll contact portion of the first relay conveyance roll pair 65. As the flexible sheet 78, for example, a synthetic resin sheet (film) consisting of polyethylene terephthalate (PET) or the like is applied.

Furthermore, in the introduction conveyance path 6K, as illustrated in FIG. 7, a rotating body (roller) 79 is provided at a position of the pair of sheet guide member 77b close to the introduction port 16, the sheet guide member 77b being arranged on the inner side (upper side) of the bending of the pair of sheet guide members 77a and 77b.

The rotating body 79 is provided such that a part thereof protrudes into the conveyance space of the introduction conveyance path 6K. In this manner, the rotating body 79 reduces the conveyance resistance due to the contact of the sheet 9 (9E, 9F) passing through the introduction conveyance path 6K with the sheet guide members 77a and 77b, and thereby ensures satisfactory conveyance performance.

Next, the external paper feeding device 8 will be described.

The external paper feeding device 8 is a device that supplies desired sheets 9 (9E, 9F) to the image forming apparatus 1 from the outside.

In addition, as illustrated in FIGS. 1 and 5, the external paper feeding device 8 includes a housing 80, a large capacity sheet tray 81, a special sheet tray 83, and a drive device, a power supply device, and a control device (not illustrated). A dash-dot chain line of the external paper feeding device 8 in FIGS. 1 and 5 indicates a conveyance path 88 when the sheet 9 is conveyed inside the housing 80.

The housing 80 is a box-shaped structure manufactured to have a desired external shape using materials such as structural materials such as frames for skeletons, panels, and exterior materials such as opening/closing doors.

As illustrated in FIG. 1, the housing 80 in the first exemplary embodiment is configured as a housing with an external shape consisting of a shape and a dimension which allow the housing 80 can be used by being arranged below the manual feed tray 5 of the image forming apparatus 1.

Specifically, as illustrated in FIG. 5, the housing 80 has at least a right side surface 80a, an upper surface 80b, and an inclined surface 80c.

The right side surface 80a is a surface portion that faces the left side surface 11 of the housing 10 of the image forming apparatus 1 and extends in the up-down direction. The upper surface 80b is a surface portion that extends in the left and right horizontal direction below the manual feed tray 5 of the image forming apparatus 1. The inclined surface 80c is a surface portion that extends from the upper end of the right side surface 80a to the right end of the upper surface 80b by being inclined diagonally upward.

In addition, a feeding port 87 that feeds the sheet 9E or 9F accommodated in the large capacity sheet tray 81 or the special sheet tray 83 toward the image forming apparatus 1 is provided on the right side surface 80a of the housing 80. The feeding port 87 is provided at a position of the right side surface 80a, which faces the introduction port 16 of the image forming apparatus 1.

The large capacity sheet tray 81 is a tray that can accommodate more sheets 9E than the sheet tray 4 (4A, 4B, 4C) in the image forming apparatus 1.

The large capacity sheet tray 81 is configured by a large capacity tray body, a first external feeding device 82, and the like.

The large capacity tray body is a structure having a loading lifting plate (not illustrated) on which the sheets 9E are loaded and which moves up and down in the up-down direction inside the housing 80.

In addition, the first external feeding device 82 is a device that feeds the uppermost sheet 9E accommodated in the large capacity tray body.

Similar to the case of the first feeding device 42A or the like in the image forming apparatus 1, the first external feeding device 82 includes a pickup roll 82a, a drive feed roll 82b, and a conveyance stop roll 82c.

The special sheet tray 83 is a tray that accommodates sheets 9F for special purposes. For example, in a case where an image is formed on a plurality of sheets 9 of any of the sheets 9A to 9E in the image forming apparatus 1, the sheet 9F for special purposes is used by being supplied to be inserted at the beginning, middle, or end of the plurality of sheets 9.

Also in the special sheet tray 83, a second external feeding device 84 that feeds the uppermost sheet among the accommodated sheets 9F is provided.

Similar to the case of the first feeding device 42A or the like in the image forming apparatus 1, the second external feeding device 84 includes a pickup roll 84a, a drive feed roll 84b, and a conveyance stop roll 84c.

In addition, in the external paper feeding device 8, as illustrated in FIG. 5 or the like, a first external feed conveyance path 88A is provided from the first external feeding device 82 of the large capacity sheet tray 81 to the feeding port 87.

The first external feed conveyance path 88A is configured by a discharge conveyance roll pair 85, and a pair of sheet conveyance members (not illustrated).

The first external feed conveyance path 88A is a conveyance path that is a conveyance route with a shape extending in an approximately horizontal state toward the feeding port 87 in the left-right direction after guiding the sheet 9E fed from the first external feeding device 82 to the discharge conveyance roll pair 85 using the pair of sheet conveyance members (not illustrated).

As illustrated in FIG. 5 or the like, the discharge conveyance roll pair 85 is a pair of rolls in which a drive conveyance roll 85a and a driven conveyance roll 85b are combined.

In the drive conveyance roll 85a, a plurality of roll bodies are fixed at intervals to the rotation axis that is rotatably supported. The drive conveyance roll 85a is driven to rotate by rotational power transmitted from a drive device (not illustrated) to the rotation axis. In the driven conveyance roll 85b, a plurality of roll bodies are fixed at intervals to the rotation axis that is rotatably supported. The driven conveyance roll 85b rotates as a result of the roll bodies thereof contacting the rotating roll bodies of the drive conveyance roll 85a with a predetermined pressure.

In addition, as illustrated in FIG. 5 or the like, the discharge conveyance roll pair 85 is arranged at a portion, which is close to the feeding port 87, on the downstream side of the first external feed conveyance path 88A.

Furthermore, the discharge conveyance roll pair 85 is arranged such that the axial center of the drive conveyance roll 85a and the axial center of the driven conveyance roll 85b are lined up in the up-down direction, at approximately the same position in the left and right horizontal direction. Moreover, the discharge conveyance roll pair 85 is arranged such that the drive conveyance roll 85a is present above the driven conveyance roll 85b.

Furthermore, in the external paper feeding device 8, as illustrated in FIG. 5 or the like, a second external feed conveyance path 88B is provided from the second external feeding device 84 of the special sheet tray 83 to the discharge conveyance roll pair 85. The second external feed conveyance path 88B is formed to be joined to the first external feed conveyance path 88A before the discharge conveyance roll pair 85.

The second external feed conveyance path 88B is configured by an external relay conveyance roll pair 86, and a pair of sheet conveyance members (not illustrated).

The second external feed conveyance path 88B is a conveyance path that is a conveyance route with a shape extending in a state of being slightly bent diagonally to the lower right side toward the discharge conveyance roll pair 85 after guiding the sheet 9F fed from the second external feeding device 84 to the external relay conveyance roll pair 86 using the pair of sheet conveyance members (not illustrated).

As illustrated in FIG. 5 or the like, the external relay conveyance roll pair 86 is arranged at an intermediate position of the second external feed conveyance path 88B, and is a pair of rolls in which a drive conveyance roll 86a and a driven conveyance roll 86b are combined.

In addition, the external relay conveyance roll pair 86 is arranged such that the axial center of the drive conveyance roll 86a and the axial center of the driven conveyance roll 86b are present on a straight line slightly inclined to the right side. Moreover, the external relay conveyance roll pair 86 is arranged such that the drive conveyance roll 86a is present above the driven conveyance roll 86b.

In the image forming apparatus 1, in a case of forming an image on the sheet 9 (9E, 9F) supplied from the external paper feeding device 8, the sheet 9E in the large capacity sheet tray 81 or the sheet 9F in the special sheet tray 83 is finally fed from the feeding port 87 of the external paper feeding device 8, and is supplied to the image forming apparatus 1.

In this case, the sheet 9E accommodated in the large capacity sheet tray 81 is fed to the first external feed conveyance path 88A by the first external feeding device 82, and then is fed to the outside of the housing 80 via the feeding port 87 by receiving the conveying force of the discharge conveyance roll pair 85.

In addition, the sheet 9F accommodated in the special sheet tray 83 is fed to the second external feed conveyance path 88B by the second external feeding device 84 to be joined to the first external feed conveyance path 88A, and then is fed to the outside of the housing 80 via the feeding port 87 by receiving the conveying force of the discharge conveyance roll pair 85.

Subsequently, the sheets 9E and 9F fed from the feeding port 87 of the external paper feeding device 8 are introduced to the introduction conveyance path 6K via the introduction port 16 of the image forming apparatus 1, and are conveyed up to the first relay conveyance roll pair 65.

Here, in the image forming apparatus 1, the first relay conveyance roll pair 65 is arranged close to the left side surface 11 of the housing 10, and is also arranged at a position close to the introduction port 16.

Therefore, the introduction conveyance path 6K is a conveyance route having a small curvature in which the conveyance route is sharply bent diagonally upward within a short distance from the introduction port 16 to the first relay conveyance roll pair 65.

As a result, the conveyance resistance of the sheets 9E and 9F fed from the external paper feeding device 8 is increased in a case where the sheets 9E and 9F pass through the introduction conveyance path 6K.

On the other hand, in the image forming apparatus 1, the introduction conveyance path 6K is configured as a conveyance path consisting of a conveyance route bent once to protrude to a side away from the left side surface 11 of the housing 10 and reaching the first relay conveyance roll pair 65.

In this manner, with the image forming apparatus 1, the sheets 9E and 9F supplied from the external paper feeding device 8 are easily received by the roll contact portion of the first relay conveyance roll pair 65 and thus are satisfactorily conveyed as compared with a case where the introduction conveyance path 6K is configured as a conveyance path extending linearly from the introduction port 16 to the first relay conveyance roll pair 65.

In addition, in the image forming apparatus 1, the rotating body 79 is provided in the introduction conveyance path 6K.

In this manner, with the image forming apparatus 1, in a case where the sheets 9E and 9F in this case pass through the introduction conveyance path 6K by coming into contact with the rotating body 79, the conveyance resistance for the sheets 9E and 9F in the introduction conveyance path 6K is reduced, and thus the sheets 9E and 9F are satisfactorily conveyed in the introduction conveyance path 6K as compared with a case where the rotating body 79 is not provided.

Furthermore, in the image forming apparatus 1, a portion of the introduction conveyance path 6K before the first relay conveyance roll pair 65 is configured by the flexible sheet 78.

In this manner, with the image forming apparatus 1, even in a case where there is not enough installation space at a portion on the front side of the introduction conveyance path 6K before the first relay conveyance roll pair 65, the sheets 9E and 9F introduced through the introduction conveyance path 6K are guided to the first relay conveyance roll pair 65 by a guiding action of the flexible sheet 78 to be smoothly received.

This point will be further described. First, in the image forming apparatus 1, in particular, since the first relay conveyance roll pair 65 is arranged close to the left side surface 11 of the housing 10, the interval between the introduction port 16 and the first relay conveyance roll pair 65 in the left and right horizontal direction becomes narrower. Therefore, there is not enough installation space for installing the introduction conveyance path 6K or the like on the front side of the first relay conveyance roll pair 65. In addition, it is difficult to arrange the introduction conveyance path 6K consisting of, for example, a plastic molded product, on the front side of the first relay conveyance roll pair 65.

Thus, in the image forming apparatus 1, the portion of the introduction conveyance path 6K on the front side of the first relay conveyance roll pair 65 is configured by the flexible sheet 78.

In addition, in the external paper feeding device 8, the discharge conveyance roll pair 85 is arranged at a position on the front side of the feeding port 87 such that the drive conveyance roll 85a is positioned above the driven conveyance roll 85b.

In this manner, in the external paper feeding device 8, the sheets 9E and 9F fed through the discharge conveyance roll pair 85 are conveyed so as to be lifted upward by receiving the winding action during the rotational driving of the drive conveyance roll 85a.

### Modification Example

The present invention is not limited to the configuration exemplified as the first exemplary embodiment, and various modifications and alterations can be made without changing the gist of each invention described in the claims. In addition, the present invention also includes the following modification examples, for example.

The manual feed tray 5 in the image forming apparatus 1 may protrude from the right side surface 12 of the housing 10. In this case, the arrangement of components relating to the manual feed tray 5, such as the manual feeding device 53, the first sheet tray 4A, the first feeding device 42A, and the common conveyance roll pair 61, is also adjusted and changed in the left-right direction.

The image forming unit 2 in the image forming apparatus 1 may adopt an image forming method other than the electrophotographic method. The image forming method other than the electrophotographic method is, for example, a droplet jetting method, a thermosensitive method, or the like. In addition, the image forming unit 2 is not limited to one that forms multicolor (color) images, but may be one that forms monochrome images.

The image forming apparatus 1 may be one that cannot be used by connecting the external paper feeding device 8.

The number of sheet trays 4 in the image forming apparatus 1 is not limited to three, and may be any other number.

### Additional Remarks

(((1)))

An image forming apparatus comprising:
a housing that has left and right side surfaces;
a manual feed tray that protrudes from one side surface of the left and right side surfaces;
a manual feeding device that feeds a sheet from the manual feed tray;
a first sheet tray that is arranged inside the housing, and faces the manual feed tray such that at least a part of the first sheet tray overlaps one end portion of the manual feed tray in a gravity direction;
a first feeding device that feeds a sheet from the first sheet tray; and
a common conveyance roll pair that is arranged inside the housing, and first receives and conveys both the sheet fed from the first feeding device and the sheet fed from the manual feeding device.
   (((2)))

The image forming apparatus according to (((1))),
wherein the common conveyance roll pair is arranged between the first feeding device and the manual feeding device, at a position which is diagonally upwardly away from both the first feeding device and the manual feeding device and at which conveyance paths are joined.
   (((3)))

The image forming apparatus according to (((1))) or (((2))),
wherein the manual feeding device is arranged to be present inside the housing.
   (((4)))

The image forming apparatus according to any one of (((1))) to (((3))),
wherein the first feeding device is arranged at a position close to the manual feeding device to leave a distance corresponding to a left and right width of the common conveyance roll pair.
   (((5)))

The image forming apparatus according to any one of (((1))) to (((4))),
wherein the first sheet tray is configured as a tray that accommodates an A3 size sheet.
   (((6)))

The image forming apparatus according to any one of (((1)) to ((5))),
wherein the manual feed tray is configured such that an inclination angle α of an accommodation surface accommodating a sheet with respect to a horizontal line satisfies 5°<α≤8°.
   (((7)))

The image forming apparatus according to any one of (((1))) to (((6))),
wherein the common conveyance roll pair is a pair of rolls in which a drive conveyance roll that is driven to rotate and a driven conveyance roll that rotates as a result of contact with the drive conveyance roll are combined, and
the drive conveyance roll is arranged on a side further away from the one side surface than the driven conveyance roll in a left and right horizontal direction.
   (((8)))

The image forming apparatus according to any one of (((1))) to (((7))),
wherein the manual feeding device includes a drive feed roll that is driven to rotate and feeds a sheet, and a conveyance stop roll that is in contact with the drive feed roll to prevent conveyance of an excess sheet overlapped and conveyed by the drive feed roll, and
the drive feed roll is arranged above the conveyance stop roll, and is arranged close to the driven conveyance roll of the common conveyance roll pair.
   (((9)))

The image forming apparatus according to any one of (((1))) to (((8))),
wherein the first feeding device is arranged at a position close to a side further away from the one side surface than a position directly below the common conveyance roll pair.
   (((10)))

The image forming apparatus according to any one of (((1))) to (((9))), further comprising:
a second sheet tray that is arranged below the first sheet tray inside the housing;
a second feeding device that feeds a sheet from the second sheet tray; and
a relay conveyance roll pair that is arranged at a position which is diagonally upwardly away from the second feeding device to be close to the one side surface, and conveys the sheet fed from the second sheet tray by first receiving the sheet and relaying the sheet to the common conveyance roll pair,
wherein the second feeding device is arranged at a position shifted to a side closer to the one side surface than the first feeding device, and
the relay conveyance roll pair is arranged at a position that is below the common conveyance roll pair and is shifted to a side closer to the one side surface than the common conveyance roll pair and the second feeding device.
   (((11)))

The image forming apparatus according to (((10))), further comprising:
a relay conveyance path through which a sheet is guided and conveyed from the relay conveyance roll pair to the common conveyance roll pair,
wherein the relay conveyance path is configured as a conveyance path consisting of a conveyance route with a shape that is once bent to protrude in a direction away from the one side surface and then extends toward the common conveyance roll pair linearly along the gravity direction.
   (((12)))

The image forming apparatus according to (((10))) or (((11))), further comprising:
an introduction port that is provided at a portion of the one side surface to face the second feeding device such that the portion at least partially overlaps the second feeding device in the gravity direction, and that introduces a sheet supplied from an outside of the housing; and
an introduction conveyance path that is provided between the introduction port and the relay conveyance roll pair, and through which the sheet introduced from the introduction port is guided and conveyed to be first received by the relay conveyance roll pair,
wherein a portion of the introduction conveyance path before the relay conveyance roll pair is configured by a flexible sheet that guides a sheet to the relay conveyance roll pair.
   (((13)))

The image forming apparatus according to any one of (((10))) to (((12))),
wherein the relay conveyance roll pair is a pair of rolls in which a drive conveyance roll that is driven to rotate and a driven conveyance roll that rotates as a result of contact with the drive conveyance roll are combined, and
the drive conveyance roll is arranged on a side further away from the one side surface than the driven conveyance roll.
   (((14)))

The image forming apparatus according to any one of (((1))) to (((13))), further comprising:
an image forming unit that is arranged inside the housing, and forms an image on a sheet; and
an adjustment conveyance roll pair that is arranged inside the housing, and conveys a sheet by adjusting a timing for feeding the sheet into the image forming unit,
wherein the common conveyance roll pair is arranged at a position that is below the adjustment conveyance roll pair and that is shifted to a side closer to the one side surface than the adjustment conveyance roll pair.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a housing that has left and right side surfaces;
a manual feed tray that protrudes from one side surface of the left and right side surfaces;
a manual feeding device that feeds a sheet from the manual feed tray;
a first sheet tray that is arranged inside the housing, and faces the manual feed tray such that at least a part of the first sheet tray overlaps one end portion of the manual feed tray in a gravity direction;
a first feeding device that feeds a sheet from the first sheet tray; and
a common conveyance roll pair that is arranged inside the housing, and first receives and conveys both the sheet fed from the first feeding device and the sheet fed from the manual feeding device.

2. The image forming apparatus according to claim 1,
wherein the common conveyance roll pair is arranged between the first feeding device and the manual feeding device, at a position which is diagonally upwardly away from both the first feeding device and the manual feeding device and at which conveyance paths are joined.

3. The image forming apparatus according to claim 2,
wherein the manual feeding device is arranged to be present inside the housing.

4. The image forming apparatus according to claim 3,
wherein the first feeding device is arranged at a position close to the manual feeding device to leave a distance corresponding to a left and right width of the common conveyance roll pair.

5. The image forming apparatus according to claim 4,
wherein the first sheet tray is configured as a tray that accommodates an A3 size sheet.

6. The image forming apparatus according to claim 2,
wherein the manual feed tray is configured such that an inclination angle α of an accommodation surface accommodating a sheet with respect to a horizontal line satisfies 5°<α≤8°.

7. The image forming apparatus according to claim 1,
wherein the common conveyance roll pair is a pair of rolls in which a drive conveyance roll that is driven to rotate and a driven conveyance roll that rotates as a result of contact with the drive conveyance roll are combined, and
the drive conveyance roll is arranged on a side further away from the one side surface than the driven conveyance roll in a left and right horizontal direction.

8. The image forming apparatus according to claim 7,
wherein the manual feeding device includes a drive feed roll that is driven to rotate and feeds a sheet, and a conveyance stop roll that is in contact with the drive feed roll to prevent conveyance of an excess sheet overlapped and conveyed by the drive feed roll, and
the drive feed roll is arranged above the conveyance stop roll, and is arranged close to the driven conveyance roll of the common conveyance roll pair.

9. The image forming apparatus according to claim 7,
wherein the first feeding device is arranged at a position close to a side further away from the one side surface than a position directly below the common conveyance roll pair.

10. The image forming apparatus according to claim 1, further comprising:
a second sheet tray that is arranged below the first sheet tray inside the housing;
a second feeding device that feeds a sheet from the second sheet tray; and
a relay conveyance roll pair that is arranged at a position which is diagonally upwardly away from the second feeding device to be close to the one side surface, and conveys the sheet fed from the second sheet tray by first receiving the sheet and relaying the sheet to the common conveyance roll pair,
wherein the second feeding device is arranged at a position shifted to a side closer to the one side surface than the first feeding device, and
the relay conveyance roll pair is arranged at a position that is below the common conveyance roll pair and is shifted to a side closer to the one side surface than the common conveyance roll pair and the second feeding device.

11. The image forming apparatus according to claim 10, further comprising:
a relay conveyance path through which a sheet is guided and conveyed from the relay conveyance roll pair to the common conveyance roll pair,
wherein the relay conveyance path is configured as a conveyance path consisting of a conveyance route with a shape that is once bent to protrude in a direction away from the one side surface and then extends toward the common conveyance roll pair linearly along the gravity direction.

12. The image forming apparatus according to claim 10, further comprising:
an introduction port that is provided at a portion of the one side surface to face the second feeding device such that the portion at least partially overlaps the second feeding device in the gravity direction, and that introduces a sheet supplied from an outside of the housing; and
an introduction conveyance path that is provided between the introduction port and the relay conveyance roll pair, and through which the sheet introduced from the introduction port is guided and conveyed to be first received by the relay conveyance roll pair,
wherein a portion of the introduction conveyance path before the relay conveyance roll pair is configured by a flexible sheet that guides a sheet to the relay conveyance roll pair.

13. The image forming apparatus according to claim 10,
wherein the relay conveyance roll pair is a pair of rolls in which a drive conveyance roll that is driven to rotate and a driven conveyance roll that rotates as a result of contact with the drive conveyance roll are combined, and
the drive conveyance roll is arranged on a side further away from the one side surface than the driven conveyance roll.

14. The image forming apparatus according to claim 1, further comprising:
an image forming unit that is arranged inside the housing, and forms an image on a sheet; and
an adjustment conveyance roll pair that is arranged inside the housing, and conveys a sheet by adjusting a timing for feeding the sheet into the image forming unit,
wherein the common conveyance roll pair is arranged at a position that is below the adjustment conveyance roll pair and that is shifted to a side closer to the one side surface than the adjustment conveyance roll pair.

15. The image forming apparatus according to claim 2, further comprising:
an image forming unit that is arranged inside the housing, and forms an image on a sheet; and
an adjustment conveyance roll pair that is arranged inside the housing, and conveys a sheet by adjusting a timing for feeding the sheet into the image forming unit,
wherein the common conveyance roll pair is arranged at a position that is below the adjustment conveyance roll pair and that is shifted to a side closer to the one side surface than the adjustment conveyance roll pair.

16. The image forming apparatus according to claim 3, further comprising:
an image forming unit that is arranged inside the housing, and forms an image on a sheet; and
an adjustment conveyance roll pair that is arranged inside the housing, and conveys a sheet by adjusting a timing for feeding the sheet into the image forming unit,
wherein the common conveyance roll pair is arranged at a position that is below the adjustment conveyance roll pair and that is shifted to a side closer to the one side surface than the adjustment conveyance roll pair.

17. The image forming apparatus according to claim 4, further comprising:
an image forming unit that is arranged inside the housing, and forms an image on a sheet; and
an adjustment conveyance roll pair that is arranged inside the housing, and conveys a sheet by adjusting a timing for feeding the sheet into the image forming unit,
wherein the common conveyance roll pair is arranged at a position that is below the adjustment conveyance roll pair and that is shifted to a side closer to the one side surface than the adjustment conveyance roll pair.

18. The image forming apparatus according to claim 5, further comprising:
an image forming unit that is arranged inside the housing, and forms an image on a sheet; and
an adjustment conveyance roll pair that is arranged inside the housing, and conveys a sheet by adjusting a timing for feeding the sheet into the image forming unit,
wherein the common conveyance roll pair is arranged at a position that is below the adjustment conveyance roll pair and that is shifted to a side closer to the one side surface than the adjustment conveyance roll pair.

19. The image forming apparatus according to claim 6, further comprising:
an image forming unit that is arranged inside the housing, and forms an image on a sheet; and
an adjustment conveyance roll pair that is arranged inside the housing, and conveys a sheet by adjusting a timing for feeding the sheet into the image forming unit,
wherein the common conveyance roll pair is arranged at a position that is below the adjustment conveyance roll pair and that is shifted to a side closer to the one side surface than the adjustment conveyance roll pair.

20. The image forming apparatus according to claim 7, further comprising:
an image forming unit that is arranged inside the housing, and forms an image on a sheet; and
an adjustment conveyance roll pair that is arranged inside the housing, and conveys a sheet by adjusting a timing for feeding the sheet into the image forming unit,
wherein the common conveyance roll pair is arranged at a position that is below the adjustment conveyance roll pair and that is shifted to a side closer to the one side surface than the adjustment conveyance roll pair.
